(19) United States
(12) Patent Application Publication
(10) Pub. No.: US 2022/0012758 A1
(43) Pub. Date: Jan. 13, 2022

(54) INFORMATION PROCESSING METHOD, INFORMATION PROCESSING SERVER, STORAGE MEDIUM, AND INFORMATION PROCESSING SYSTEM

(71) Applicant: HONDA MOTOR CO., LTD., Tokyo (JP)

(72) Inventors: Hodaka Mukohara, Wako-shi (JP); Kobue Nose, Wako-shi (JP); Keiko Kataoka, Wako-shi (JP)

(73) Assignee: HONDA MOTOR CO., LTD., Tokyo (JP)

(21) Appl. No.: 17/484,769

(22) Filed: Sep. 24, 2021

Related U.S. Application Data
(63) Continuation of application No. PCT/JP2019/014251, filed on Mar. 29, 2019.

(51) Int. Cl. G06Q 30/02; G06K 9/00; G06Q 30/06; G06Q 10/00

(52) U.S. Cl. CPC G06Q 30/0208; G06K 9/00845; G06Q 10/20; G06Q 30/0645; G06K 9/00798

(57) ABSTRACT

An information processing method includes acquiring, from an external device, evaluation information for evaluating a driver who drives a vehicle and calculating reliability of the driver based on the evaluation information. The method further includes converting the calculated reliability into an amount and granting the converted amount to the driver, the amount being in a transaction unit that can be used for rental payment for the vehicle. The evaluation information includes status of the rental payment of the driver and at least one of efficiency of labor, an amount of labor and regularity of labor of the driver.

### CROSS-REFERENCE TO RELATED APPLICATION(S)

This application is a continuation of International Patent Application No. PCT/JP2019/014251 filed on Mar. 29, 2019, the entire disclosure of which is incorporated herein by reference.

### TECHNICAL FIELD

The present invention relates to an information processing method, an information processing server, a storage medium, and an information processing system.

### BACKGROUND ART

There is known a conventional method for calculating an insurance premium for a mobile object, in which the state of maintenance of the mobile object is taken into consideration in setting the insurance premium for the mobile object (Patent Literature 1). Patent Literature 1 discloses a technique for calculating an insurance premium by giving a predetermined discount on a basic premium when the state of maintenance of the mobile object satisfies a predetermined maintenance condition.

### CITATION LIST

### Patent Literature

PTL1: Japanese Patent Laid-Open No. 2018-60247

However, offering a discount on an insurance premium according to the state of maintenance is merely disclosed in the description of the method for calculating an insurance premium for a mobile object disclosed in Patent Literature 1. That is, no consideration is given to enabling accumulated reliability to be used for the purpose of maintenance of a vehicle (mobile object) (for example, leasing a mobile object).

### SUMMARY OF THE INVENTION

The present invention has been made in view of the above problem, and an object of the present invention is to provide a technique for motivating a driver to enhance the quality of driving so as to use the driver's reliability for the purpose of maintenance of a vehicle.

In order to solve the aforementioned problems, one aspect of the present disclosure provides an information processing method comprising: acquiring, from an external device, evaluation information for evaluating a driver who drives a vehicle; calculating reliability of the driver based on the evaluation information; and converting the calculated reliability into an amount and granting the converted amount to the driver, the amount being in a transaction unit that can be used for rental payment for the vehicle, wherein the evaluation information includes status of the rental payment of the driver and at least one of efficiency of labor, an amount of labor and regularity of labor of the driver.

Another aspect of the present disclosure provides an information processing server comprising: one or more processors; and a memory storing instructions which, when the instructions are executed by the one or more processors, cause the image processing server to: acquire, from an external device, evaluation information for evaluating a driver who drives a vehicle; calculate reliability of the driver based on the evaluation information; and convert the calculated reliability into an amount and grant the converted amount to the driver, the amount being in a transaction unit that can be used for rental payment for the vehicle, wherein the evaluation information includes status of the rental payment of the driver and at least one of efficiency of labor, an amount of labor and regularity of labor of the driver.

Still another aspect of the present disclosure provides a storage medium storing a computer program comprising instructions for causing one or more processors executing the computer program to: acquire, from an external device, evaluation information for evaluating a driver who drives a vehicle; calculate reliability of the driver based on the evaluation information; and convert the calculated reliability into an amount and grant the converted amount to the driver, the amount being in a transaction unit that can be used for rental payment for the vehicle, wherein the evaluation information includes status of the rental payment of the driver and at least one of efficiency of labor, an amount of labor and regularity of labor of the driver.

Yet another aspect of the present disclosure provides an information processing system comprising an information processing server and a vehicle, wherein the vehicle includes a transmitter for transmitting, to the information processing server, evaluation information for evaluating a driver who drives the vehicle, and the information processing server includes: one or more processors; and a memory storing instructions which, when the instructions are executed by the one or more processors, cause the image processing server to: acquire, from the vehicle, the evaluation information for evaluating the driver's driving of the vehicle; calculate reliability of the driver based on the evaluation information; and convert the calculated reliability into an amount and grant the converted amount to the driver, the amount being in a transaction unit that can be used for rental payment for the vehicle, wherein the evaluation information includes status of the rental payment of the driver and at least one of efficiency of labor, an amount of labor and regularity of labor of the driver.

Still another aspect of the present disclosure provides an information processing method comprising: acquiring, from an external device, evaluation information for evaluating a driver who drives a vehicle; calculating reliability of the driver based on the evaluation information; and converting the calculated reliability into an amount and granting the converted amount to the driver, the amount being in a transaction unit that can be used for rental payment for the vehicle, wherein the evaluation information includes status of the rental payment of the driver, and the converted amount can be used for payment for the purchase of the vehicle.

According to the present invention, it is possible to provide a technique for motivating the driver to enhance the quality of driving so as to use the driver's reliability for the purpose of maintenance of the vehicle.

Other features and advantages of the present invention will be apparent from the following description taken in conjunction with the accompanying drawings. Note that the same reference numerals denote the same or like components throughout the accompanying drawings.

### BRIEF DESCRIPTION OF DRAWINGS

The accompanying drawings, which are incorporated in and constitute a part of the specification, illustrate embodiments of the invention and, together with the description, serve to explain principles of the invention.

FIG. 1 is a diagram showing an example of an information processing system according to a present embodiment of the present invention.

FIG. 2 is a block diagram showing a functional configuration example of an information processing server according to the present embodiment.

FIG. 3 is a block diagram showing an example of a software configuration of the information processing server according to the present embodiment.

FIG. 4 is a flowchart showing a series of operation steps of a reliability conversion process according to the present embodiment.

FIG. 5 is a block diagram showing a functional configuration example of a vehicle according to the present embodiment.

FIG. 6 is a diagram showing an example of a table for calculating reliability from traveling data according to the present embodiment.

FIG. 7 is a diagram showing an example of an operation screen for inputting qualitative evaluation information according to the present embodiment.

### DESCRIPTION OF EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### System Overview

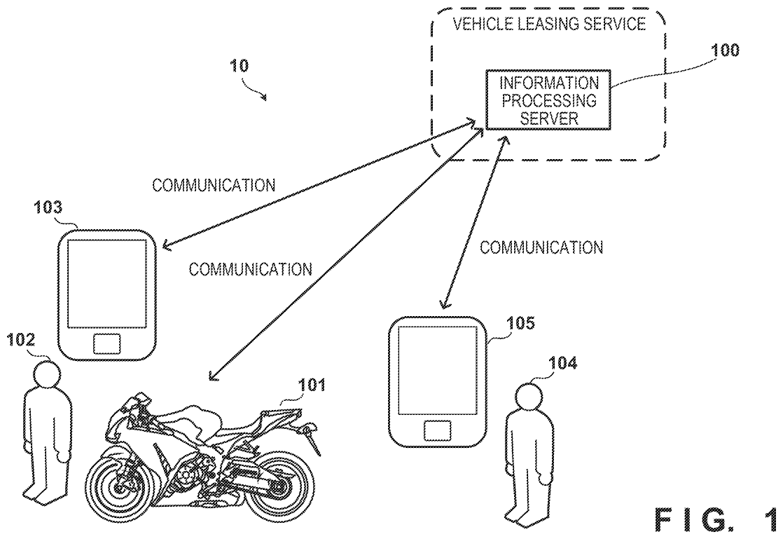

FIG. 1 is a diagram showing a configuration example of an information processing system according to a present embodiment. An information processing system 10 according to the present embodiment includes an information processing server 100 and a vehicle 101. Furthermore, the information processing system 10 may further include at least either a communication device 103 to be used by a driver 102 or a communication device 105 to be used by a passenger 104.

The driver 102 is a driver who drives the vehicle 101. For example, the driver 102 picks up the passenger 104 and drives the vehicle 101 to take the passenger 104 to a destination in return for payment of a fare. That is, a case where the driver 102 works as a driver of the vehicle 101 will be described as an example in the following description. However, the driving may be performed as work. Alternatively, the driving may be performed for other purposes. For example, the vehicle 101 is leased to the driver 102 from a company that provides a vehicle leasing service, and the driver 102 pays a consideration (makes a rental payment) for the leasing service every predetermined period. Note that a case where the vehicle 101 is a two-wheeled vehicle will be described as an example in the present embodiment, but the vehicle 101 may be a four-wheeled vehicle.

The information processing server 100 is a server to be used for a vehicle leasing service. The information processing server 100 evaluates the driver's driving, and manages the reliability of the driver. The reliability of the driver is managed such that the reliability of the driver accumulates as the driver drives the vehicle more often and appropriately. The information processing server 100 also grants a point to the driver according to the driver's reliability. The point is issued by the leasing service company. The point is a transaction unit that can be used for predetermined payment. The point can be converted into the currency of a country in which the service is provided, but is not the currency itself. This point can be used for, for example, rental payment for the leasing service described above. Furthermore, the point can be used for not only rental payment for the vehicle but also payment of the maintenance cost of the vehicle. Alternatively, in a case where the vehicle can be purchased, the point may be used for payment of consideration for the purchase of the vehicle. In this manner, it is possible to motivate the driver to appropriately drive the vehicle, by granting the point according to the reliability.

The vehicle 101 can communicate with the information processing server 100, and transmits data (also referred to as traveling data), such as accelerations collected by a sensor of the vehicle 101, to the information processing server at any time or at a predetermined timing. The traveling data will be described below. The traveling data are included in evaluation information for evaluating the driver 102 who drives the vehicle 101. The information processing server 100 uses the acquired traveling data so as to calculate the reliability of the driver.

The communication device 105 is a communication terminal held by the passenger 104, and can communicate with the information processing server via a communication network. The passenger 104 can input driving evaluation for the driver 102 and transmit information regarding the evaluation to the information processing server 100 by using the communication device 105. In addition, the passenger 104 can pay a fare by using the communication device 105. The communication device 105 can settle payment by, for example, communicating with a server for online payment (not shown) or using a message service.

Note that while the present embodiment is based on the assumption that the passenger 104 transmits the information regarding the evaluation to the information processing server 100 via the communication device 105, the information regarding the evaluation may be input to the communication device 103 held by the driver 102 and transmitted to the information processing server 100. In this case, for example, the driver 102 interviews the passenger 104, and inputs the result of the interview to the communication device 103. The communication device 103 communicates with the information processing server 100, and transmits the input information regarding the evaluation to the information processing server 100.

### Functional Configuration Example of Information Processing Server

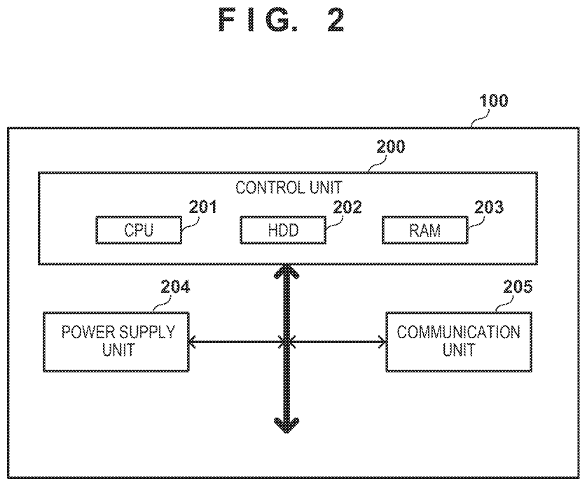

FIG. 2 is a block diagram showing a functional configuration example of the information processing server 100. A control unit 200 includes one or more central processing units (CPUs) 201, a hard disc drive (HDD) 202, and a random access memory (RAM) 203. The CPU 201 reads and executes programs stored in the HDD 202 to control various types of processing to be described below. The HDD 202 is a non-volatile storage area, and stores programs corresponding to the various types of processing. Note that a semiconductor memory may be used instead of the HDD. The RAM 203 is a volatile storage area, and is used as, for example, a working memory. Note that the control unit 200 may include a graphics processing unit (GPU), an application specific integrated circuit (ASIC), a dedicated circuit, or the like. Furthermore, the control unit 200 may be configured such that each constituent element of the control unit 200 is virtualized.

A power supply unit 204 is a part that supplies external power to the information processing server 100. A communication unit 205 is a part for communicating with the vehicle 101, the communication device 105, and the like via a communication network, and is not particularly limited in terms of a communication method, a communication protocol, and the like.

### Software Configuration of Information Processing Server

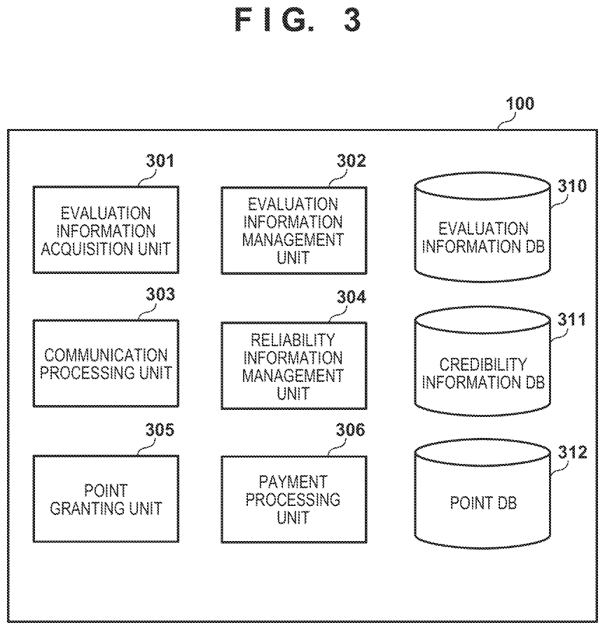

FIG. 3 is a diagram showing an example of a software configuration of the information processing server 100 according to the present embodiment. In the present embodiment, the CPU 201 reads and executes a program stored in the HDD 202 or the like to implement each processing unit. In addition, each database (DB) is included in the HDD 202. Note that FIG. 3 shows only an example of the software configuration necessary for implementation of the present embodiment, so that each software configuration of firmware, OS, middleware, a web service module, and the like is omitted.

An evaluation information acquisition unit 301 acquires the evaluation information from the vehicle 101 and the communication device 105 via a communication processing unit 303. The evaluation information acquisition unit 301 performs control for acquiring traveling data uploaded from the vehicle 101, and also performs control for acquiring qualitative evaluation data input in a web browser or an application of the communication device 105 by controlling operation of a web application. An evaluation information management unit 302 stores the traveling data and the qualitative evaluation information in association with each other, which have been acquired by the evaluation information acquisition unit 301, in an evaluation information DB 310, and manages the evaluation information. The evaluation information DB 310 is a database for storing evaluation information for each driver.

The communication processing unit 303 controls various communication protocols to be used between the communication processing unit 303 and the vehicle 101 that the driver 102 drives or the communication device 105 that the passenger 104 uses. A reliability information management unit 304 calculates a reliability score (reliability information) for each driver from the evaluation information in the evaluation information DB 310, and stores the score in a reliability information DB 311. A method for calculating the reliability score in the present embodiment will be described below. The reliability information DB 311 is a database for storing the reliability score (reliability information) for each driver.

A point granting unit 305 converts the drivers' reliability scores stored in the reliability information DB 311 into the numbers of points that can be used for rental payment and payment of maintenance costs, and grants the converted numbers of points to the drivers. The point granting unit 305 stores the granted points in a point DB 312 for each driver. In a case where a driver desires to use the granted points for rental payment and payment of the maintenance cost, a payment processing unit 306 performs payment processing by reflecting the granted points in the payment.

For example, virtual currency issued and managed by the leasing company may be used as the points that can be used for payment. In this case, the driver can settle the rental payment and the payment of the maintenance cost in the granted virtual currency. The virtual currency may be, for example, currency that is not linked to currency to be used for ordinary transactions, in terms of currency value. Of course, general-purpose virtual currency other than the virtual currency described above may be used. Alternatively, points other than virtual currency may be used such that the points can be converted into the currency to be used for ordinary transactions at a fixed ratio.

### Evaluation Information

The evaluation information management unit 302 stores, in the evaluation information DB 310, the evaluation information acquired by the evaluation information acquisition unit 301. The evaluation information stored in the evaluation information DB 310 is managed for each driver. In addition, the evaluation information for each driver is further managed for each drive (each drive is simply referred to as a passenger drive) in which the passenger 104 is carried in return for payment of a fare. That is, the evaluation information includes, for each driver, evaluation information for each of one or more passenger drives. The evaluation information of each passenger drive is associated with traveling data in the passenger drive and qualitative evaluation information in the passenger drive. The traveling data include a starting time and an ending time of the passenger drive, time-series data indicating a transition of the position of the vehicle between the starting time and the ending time, time-series data indicating a transition of the speed of the vehicle between the starting time and the ending time, and time-series data indicating a transition of the acceleration of the vehicle between the starting time and the ending time. In addition, information indicating whether the vehicle has traveled without maintenance in an appropriate period may be added to the traveling data. Furthermore, identifiers such as a passenger drive ID for identifying a passenger drive and a driver ID for identifying a driver may be added. Meanwhile, the qualitative evaluation information includes quantified information represented as evaluation values, such as information on manners that the driver has, information as to whether the driver has had an accident, and information as to whether the driver has ignored a red light. Specifically, the qualitative evaluation information includes the driver's attitude (for example, 1 to 5 points), the way the driver treats the passenger (for example, 1 to 5 points), the driver's behavior (for example, 1 to 5 points), whether the driver was wearing a helmet (for example, 0 or 1 point), and whether the driver has caused an accident while driving (for example, 0 or 1 point). In addition, the qualitative evaluation information may further include information as to whether the driver has driven through a red light (for example, 0 or 1 point). Note that although the example in which the information as to whether the driver has ignored a red light is obtained as qualitative evaluation information has been described, it may be determined whether the driver has ignored a red light by transmitting, as traveling data, a moving image captured by an imaging unit of the vehicle to the information processing server 100 and causing the information processing server to perform image analysis.

### Calculation of Reliability Score

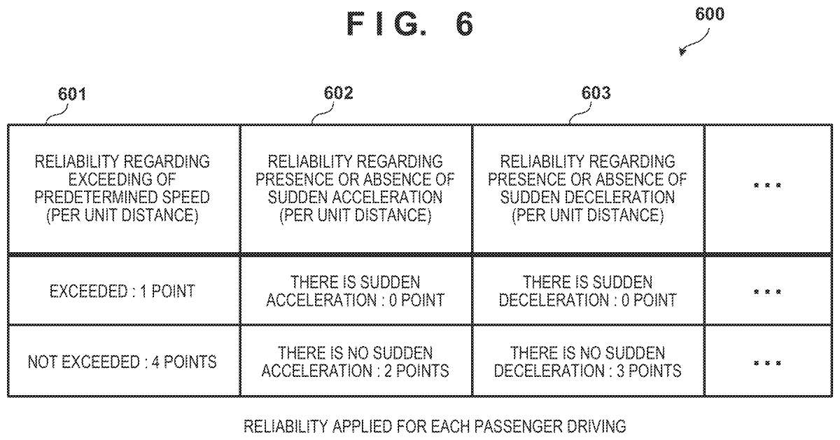

In the present embodiment, the reliability of the driver is calculated on the basis of the evaluation information described above. In the present embodiment, for example, the traveling data and the qualitative evaluation information for each passenger drive are each converted into quantified reliability (referred to as a reliability score), and are then added up. FIG. 6 shows an example of a conversion table for calculating a reliability score from the traveling data for each passenger drive. For example, cited as an example is a situation in which the driver 102 has carried the passenger 104 and ended a single passenger drive, and traveling data on the passenger drive have been uploaded to the information processing server 100. At this time, it is assumed that the vehicle has traveled a distance of 10 km (unit distance is km) in this passenger drive.

First, the information processing server 100 calculates, from the traveling data, the number of occurrences of traveling at a speed exceeding a predetermined speed threshold. Whether traveling at a speed exceeding the speed threshold has occurred is determined every time the vehicle travels a unit distance (for example, 1 km), and scores based on the table shown in FIG. 6 are added. For example, in a case where traveling at a speed exceeding the speed threshold has occurred in the first 1 km during the 10 km drive, but has not occurred in the other sections, the traveling at a speed exceeding the speed threshold scores 28 points based on a column 601 as follows: 1 point*1 (first 1 km)+3 points*9 (remaining 9 km)=28 points. The same applies to sudden acceleration and sudden deceleration. Every time the vehicle travels a unit distance (for example, 1 km), whether sudden acceleration/sudden deceleration has occurred is determined, and a score is calculated on the basis of a column 602/603. Then, the information processing server 100 adds the score calculated for traveling at a speed exceeding the speed threshold, the score calculated for sudden acceleration, and the score calculated for sudden deceleration to obtain a reliability score from the traveling data in the passenger drive. In addition, in a case where maintenance has not been performed even after a maintenance period has passed, a predetermined score may be subtracted from the reliability score.

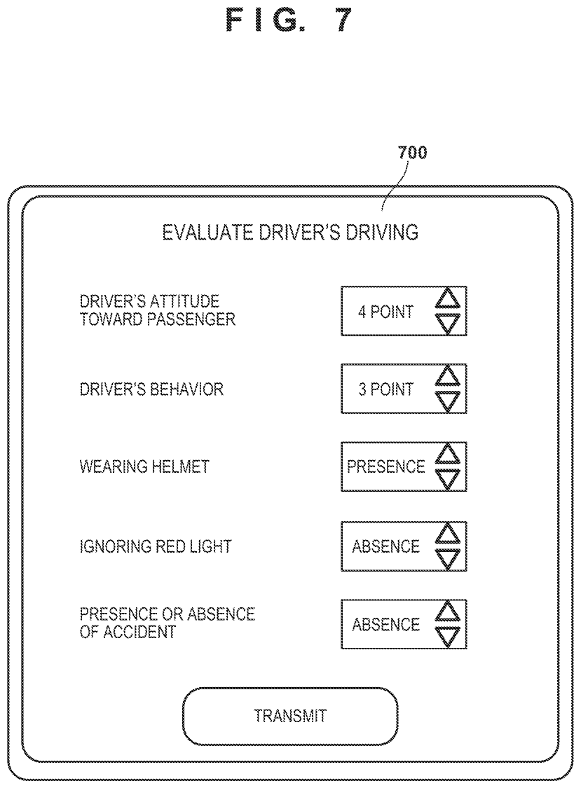

Next, calculation of a reliability score from qualitative evaluation information will be described. The qualitative evaluation information can be input by use of, for example, a screen 700 as shown in FIG. 7. For example, a passenger makes evaluation of any given items such as “the driver's attitude toward the passenger”, “the way the driver treats the passenger”, “the driver's behavior”, “whether the driver was wearing a helmet”, and “whether the driver has caused an accident while driving”. For example, for “the driver's attitude toward the passenger”, “the way the driver treats the passenger”, and “the driver's behavior”, points (1 to 5 points with the highest score at 5 points) are assigned as a reliability score in advance to the chosen evaluation (for example, 1 to 5 points with the highest score at 5 points). In addition, a score for “whether the driver was wearing a helmet” is set such that, for example, 5 points are given when “the driver was wearing a helmet”, and −10 points are given when “the driver was wearing no helmet”. Furthermore, a score for “whether the driver has caused an accident while driving” may be set such that, for example, 5 points are given when “the driver has caused no accident”, and −10 points are given when “the driver has caused an accident”. The information processing server 100 calculates a reliability score for a passenger drive by using the score of each item as, for example, a score per unit distance.

The information processing server 100 adds the reliability score derived from the traveling data and the reliability score derived from the qualitative evaluation information to obtain a reliability score for the passenger drive. Then, the information processing server 100 adds the reliability score calculated from the latest passenger drive to a reliability score calculated from a past passenger drive of a target driver, and calculates a latest reliability score for the driver.

A case where the reliability score derived from the traveling data and the reliability score derived from the qualitative evaluation information are simply added up has been described in the above example. Meanwhile, the two reliability scores may be added up after being weighted. In addition, a weighted average thereof may be calculated. As long as the traveling data and the qualitative evaluation information can be converted into quantified reliability, other methods may be used instead of these methods. Furthermore, a case where the reliability score for the passenger drive is calculated based on details of the evaluation information has been described in the above example. However, the reliability of the driver may be calculated by use of other information. That is, the accuracy or frequency of the input of the evaluation information may be used. For example, the accuracy is input by a third party reviewing the evaluation information, so that higher reliability can be given as higher accuracy is indicated by a result of the third party's review. In addition, the higher the frequency of the evaluation information, the higher the reliability can be given. Furthermore, the driver's rental payment status may be taken into consideration. For example, it is possible to grant reliability when rental payment is made without delay or when rental payment is not overdue. Furthermore, the higher the efficiency of the driver's labor or the higher the amount of labor, the higher the reliability may be given. The efficiency of labor and the amount of labor can be obtained by calculation of the number of passenger drives in a predetermined period. In addition, reliability may be granted on the basis of the regularity of labor. Reliability may be granted depending on whether a predetermined percentage of the number of passenger drives is included in a predetermined working hour.

### Functional Configuration Example of Vehicle

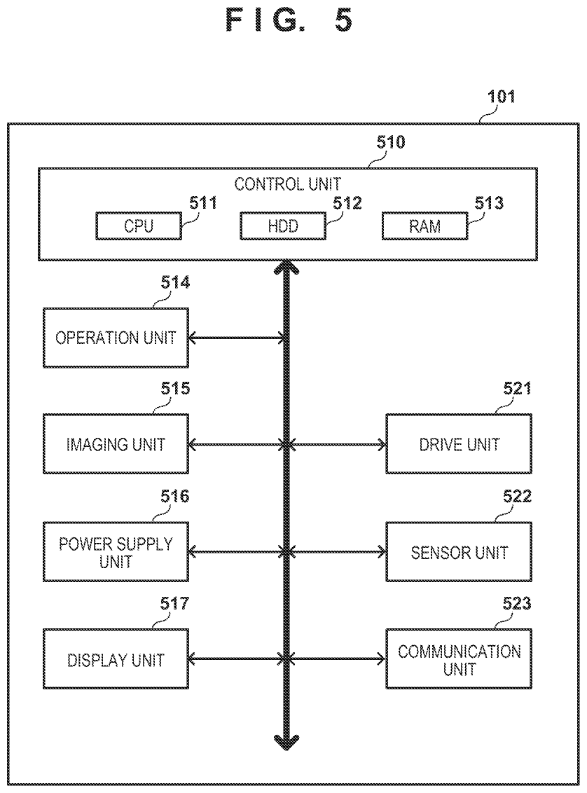

Next, a functional configuration example of the vehicle 101 will be described. FIG. 5 is a block diagram showing a functional configuration example of the vehicle 101. A control unit 510 includes one or more CPUs 511, an HDD 512, and a RAM 513. The CPU 511 reads and executes programs stored in the HDD 512 to control various types of processing in the vehicle. The HDD 512 is a non-volatile storage area, and stores programs corresponding to the various types of processing. Note that a semiconductor memory may be used instead of the HDD. The RAM 513 is a volatile storage area, and is used as, for example, a working memory. Note that the control unit 510 may include a GPU, an ASIC, a dedicated circuit, or the like.

Furthermore, the vehicle 101 according to the present embodiment includes various parts each serving as an interface for external information. Each part to be described below operates under the control of the control unit 510. An operation unit 514 is a part that receives various operations on the vehicle, and includes, for example, a switch and a touch panel. In the present embodiment, the operation unit 514 receives, for example, an operation for inputting the start and end of a passenger drive and a navigation operation. An imaging unit 515 is a part that acquires image information on surroundings, and includes, for example, a dashboard camera. In the present embodiment, for example, the imaging unit 515 acquires a captured image of a view ahead of the traveling vehicle. The imaging unit 515 may further acquire a captured image showing the state of the driver.

A power supply unit 516 is a part that supplies power to the vehicle 101, and corresponds to a battery. A display unit 517 is a part for outputting an operation menu, map data for navigation, and various types of information such as passenger drive costs, and includes a display and the like. The display unit 517 and the operation unit 514 may be integrally configured as, for example, a touch panel display.

A drive unit 521 is a part that causes the vehicle to travel, and may include, for example, an actuator, tires, a motor, and an engine. A sensor unit 522 includes various sensors for acquiring the speed and acceleration of the vehicle. Examples of the sensors may include a speed sensor, an acceleration sensor, an infrared sensor, and an image sensor. The sensors may be provided according to information to be acquired. Furthermore, the imaging unit 515 may be included in the sensor unit 522. A communication unit 523 is a part for communicating with an external device (for example, the information processing server 100) via a network, and is not particularly limited in terms of a communication method, a communication protocol, and the like. For example, the communication unit 523 transmits acquired traveling data and image information to the information processing server 100, and receives map data from a navigation server (not shown). Furthermore, the communication unit 523 may include a global positioning system (GPS) for detecting its own position information.

### Configuration of Communication Device 105

Although not shown, the communication device 105 includes a control unit including one or more CPUs, an HDD, and a RAM. The CPU of the communication device 105 reads and executes a program stored in the HDD to control display of the screen 700 shown in FIG. 7. Furthermore, the control unit of the communication device 105 transmits the evaluation of the driver input by the passenger 104 to the information processing server 100.

### Series of Operation Steps of Point Conversion Processing

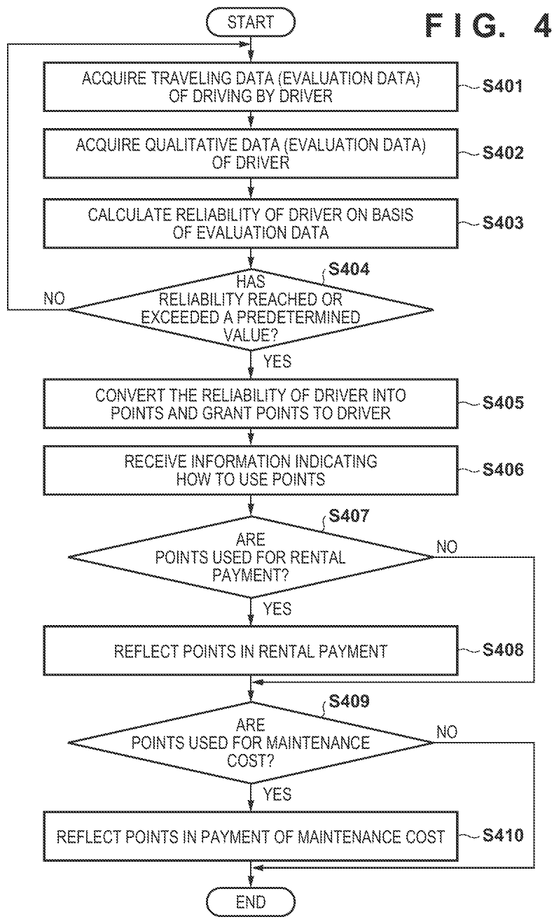

FIG. 4 is a flowchart showing a series of operation steps of point conversion processing to be performed by the information processing server 100 according to the present embodiment. In the present embodiment, the CPU 201 of the information processing server 100 reads and executes a program stored in the HDD 202 to implement the present process. Each processing step is implemented by cooperation of, for example, the parts in FIG. 2 and the processing units in FIG. 3. However, here, for the sake of simplicity, each processing step will be comprehensively described as being performed by the information processing server 100. Note that the present process is started with uploading traveling data from the vehicle 101 in a situation where the driver 102 has carried the passenger 104 and arrived at a destination (that is, a single passenger drive has ended).

In S401, the information processing server 100 acquires traveling data related to a passenger drive, which correspond to evaluation information, from the vehicle 101. As described above, the traveling data include the starting time and ending time of the passenger drive, and time-series data indicating transitions of the position, speed, and acceleration of the vehicle between the starting time and the ending time. The information processing server 100 stores the acquired traveling data in the evaluation information DB in association with the passenger drive ID and the driver ID.

In S402, the information processing server 100 acquires qualitative evaluation information, which is evaluation information, from the communication device 105. As described above, qualitative evaluation information, such as evaluation information regarding the items shown on the screen 700 shown in FIG. 7, is input by the passenger 104 and transmitted from the communication device 105 to the information processing server 100. When acquiring the qualitative evaluation information, the information processing server 100 stores the acquired qualitative evaluation information in the evaluation information DB in association with the traveling data on the same passenger drive.

In S403, the information processing server 100 calculates the reliability of the driver on the basis of the evaluation information. The information processing server 100 analyzes the traveling data on the passenger drive that is the target of processing, determines for each unit distance whether traveling at a speed exceeding a speed threshold has occurred, whether a sudden acceleration exceeding an acceleration threshold has occurred, and whether a sudden deceleration exceeding a deceleration threshold has occurred, and calculates a reliability score by the method described above with reference to FIG. 6. In addition, a reliability score is calculated on the basis of the qualitative evaluation information of the same passenger drive as described above, and is added to the reliability score based on the traveling data. The information processing server 100 adds the newly calculated reliability score for the passenger drive to the driver's reliability score accumulated after being calculated on the basis of the past passenger drive (that is, updates the reliability score). The new reliability score may be stored in the reliability information DB.

In S404, the information processing server 100 determines whether the reliability score of the driver has reached or exceeded a predetermined value. The predetermined value in the present step is a threshold for determining whether the accumulated reliability of the driver has reached or exceeded a certain level. The predetermined value may be set as an empirical or statistical value that an excellent driver can reach after establishing a track record of about several years. The same threshold value may be set for a plurality of drivers. Alternatively, different threshold values may be set for the drivers according to companies to which the drivers belong, attributes of the drivers, and the relationship with the leasing company. This enables the drivers to make payment with points at different timings. In a case where the information processing server 100 determines that the reliability score of the driver has reached or exceeded the predetermined value, the process proceeds to S405, and otherwise, the process proceeds to S401.

In S405, the information processing server 100 converts the reliability score of the driver into an amount of points, and grants the amount of points to the driver. Here, in a case where the point is, for example, virtual currency issued and managed by the leasing company, the reliability score is converted into a point to be granted to the driver on the basis of a predetermined conversion ratio of reliability to points (virtual currency). Note that the extent of the accumulated reliability score that can be converted into points may be set in advance. The information processing server 100 stores the points to be granted to the driver in the point DB 312. In addition, the information processing server 100 may notify the communication device 103 of the driver 102 that the reliability has exceeded the predetermined value and the points have been granted. In addition, the notification may include the number of granted points and indicate that the points can be used for rental payment and payment of the maintenance cost.

In S406, the information processing server 100 receives information indicating how to use points from the communication device 103 of the driver 102. The information indicating how to use points may include information on, for example, how many points among the points granted to the driver are to be used for payment of a cost and which cost is to be paid by use of the points.

In S407, the information processing server 100 determines whether points are used for rental payment for the vehicle, on the basis of the information received in S406. In a case where the information processing server 100 determines that points are used for rental payment for the vehicle, the process proceeds to S408, and otherwise, the process proceeds to S409.

In S408, the information processing server 100 reflects, in the rental payment, the number of points indicated in the information received in S406. The information processing server 100 may further process settlement of the rental payment on the basis of the reflected rental payment. In a case where the rental payment is settled by use of the virtual currency managed by the leasing company, the information processing server 100 performs a settlement process using the virtual currency.

In S409, the information processing server 100 determines whether points are used for the payment of the maintenance cost of the vehicle, on the basis of the information received in S406. In a case where the information processing server 100 determines that points are used for the payment of the maintenance cost of the vehicle, the process proceeds to S410, and otherwise, the present series of processing steps ends.

In S410, the information processing server 100 reflects, in the payment of the maintenance cost, the specified number of points among the points remaining after appropriation for the rental payment on the basis of the information received in S406. The information processing server 100 may further process settlement of the payment of the maintenance cost on the basis of the reflected maintenance cost. In a case where the payment of the maintenance cost is settled by use of the virtual currency managed by the leasing company, the information processing server 100 performs a settlement process using the virtual currency, and then terminates the present series of processing steps.

As described above, in the present embodiment, the evaluation information for evaluating the driver is acquired, and the reliability of the driver is calculated. When the reliability is accumulated, the calculated reliability is converted into the amount of points that can be used for rental payment for the vehicle, and the converted amount is granted to the driver. In this way, the driver can obtain points that can be used for payment of desired costs, such as rental payment, by driving appropriately. This motivates the driver to drive appropriately.

### SUMMARY OF EMBODIMENT

1. The information processing method (for example, FIG. 4) according to the above embodiment includes:

an acquisition step (S401, S402) of acquiring, from an external device, evaluation information for evaluating a driver who drives a vehicle;

a reliability calculation step (S403) of calculating reliability of the driver based on the evaluation information; and

a granting step (S405) of converting the calculated reliability into an amount and granting the converted amount to the driver, the amount being in a transaction unit that can be used for rental payment for the vehicle.

According to the present embodiment, it is possible to motivate a driver to enhance the quality of driving so as to use the driver's reliability for the purpose of maintenance of a vehicle.

2. The information processing method according to the above embodiment further includes:

a first reflection step of reflecting the granted amount in the rental payment to be made by the driver.

According to the present embodiment, a rental payment can be made based on the accumulated reliability.

3. In the information processing method according to the above embodiment,

the granted amount can also be used by the driver for payment of a maintenance cost of the vehicle, and

the information processing method further includes a second reflection step of reflecting the granted amount in the driver's payment of the maintenance cost of the vehicle.

According to the present embodiment, it is possible to make payment of the maintenance cost in addition to the rental payment based on the accumulated reliability.

4. In the information processing method according to the above embodiment,

the evaluation information includes at least either traveling data or qualitative evaluation of the driver, the traveling data being obtained from a sensor of the vehicle when the driver drives the vehicle.

According to the present embodiment, it is possible to evaluate the driver by using evaluation data based on the perspective of both quantitative evaluation based on traveling data and qualitative evaluation.

5. In the information processing method according to the above embodiment,

the qualitative evaluation is based on an evaluation value for evaluation of at least any of the driver's attitude, a way the driver treats a passenger, the driver's behavior, whether the driver was wearing a helmet, and whether the driver has caused an accident while driving (for example, 302 and FIG. 7), the evaluation value being provided by the passenger on the vehicle (for example, 105).

According to the present embodiment, it is possible to reflect, in reliability, qualitative evaluation given by a person other than the driver.

6. In the information processing method according to the above embodiment, the passenger is a person who has paid a fare and has taken a ride on the vehicle.

According to the present embodiment,

it is possible to improve motivation for the driver to enhance the quality of driving in a service such as a taxi service in which a passenger is carried in return for a consideration.

7. In the information processing method according to the above embodiment,

the transaction unit that can be used for the rental payment for the vehicle is a predetermined virtual currency.

According to the present embodiment, it is possible to make a rental payment or the like by using a currency administered and managed separately from the currency usually used.

8. The information processing server (for example, 100) according to the above embodiment includes:

an acquisition means for acquiring, from an external device, evaluation information for evaluating a driver who drives a vehicle;

a reliability calculation means for calculating reliability of the driver based on the evaluation information; and

a granting means for converting the calculated reliability into an amount and granting the converted amount to the driver, the amount being in a transaction unit that can be used for rental payment for the vehicle.

According to the present embodiment, it is possible to motivate a driver to enhance the quality of driving so as to use the driver's reliability for the purpose of maintenance of a vehicle.

9. The program according to the above embodiment is a program including instructions for causing one or more processors executing the program to:

acquire, from an external device, evaluation information for evaluating a driver who drives a vehicle (S401, S402);

calculate reliability of the driver based on the evaluation information (S403); and

convert the calculated reliability into an amount and grant the converted amount to the driver, the amount being in a transaction unit that can be used for rental payment for the vehicle (S405).

According to the present embodiment, it is possible to motivate a driver to enhance the quality of driving so as to use the driver's reliability for the purpose of maintenance of a vehicle.

10. The information processing system according to the above embodiment is an information processing system (for example, 10) including an information processing server (for example, 100) and a vehicle (for example, 101), wherein

the vehicle includes a transmission means (for example, 523) for transmitting, to the information processing server, evaluation information for evaluating a driver who drives the vehicle, and

the information processing server includes:

an acquisition means (for example, 301) for acquiring, from the vehicle, the evaluation information for evaluating the driver's driving of the vehicle;

a reliability calculation means (for example, 304) for calculating reliability of the driver based on the evaluation information; and

a granting means (for example, 305) for converting the calculated reliability into an amount and granting the converted amount to the driver, the amount being in a transaction unit that can be used for rental payment for the vehicle.

According to the present embodiment, it is possible to motivate a driver to enhance the quality of driving so as to use the driver's reliability for the purpose of maintenance of a vehicle.

The invention is not limited to the foregoing embodiments, and various variations/changes are possible within the spirit of the invention.

What is claimed is:

1. An information processing method comprising:
acquiring, from an external device, evaluation information for evaluating a driver who drives a vehicle;
calculating reliability of the driver based on the evaluation information; and
converting the calculated reliability into an amount and granting the converted amount to the driver, the amount being in a transaction unit that can be used for rental payment for the vehicle,
wherein the evaluation information includes status of the rental payment of the driver and at least one of efficiency of labor, an amount of labor and regularity of labor of the driver.

2. The information processing method according to claim 1, further comprising: a first reflection step of reflecting the granted amount in the rental payment to be made by the driver.

3. The information processing method according to claim 1, wherein
the granted amount can also be used by the driver for payment of a maintenance cost of the vehicle, and
the information processing method further comprises a second reflection step of reflecting the granted amount in the driver's payment of the maintenance cost of the vehicle.

4. The information processing method according to claim 1, wherein the evaluation information includes at least either traveling data or qualitative evaluation of the driver, the traveling data being obtained from a sensor of the vehicle when the driver drives the vehicle.

5. The information processing method according to claim 4, wherein the qualitative evaluation is based on an evaluation value for evaluation of at least any of the driver's attitude, a way the driver treats a passenger, the driver's behavior, whether the driver was wearing a helmet, and whether the driver has caused an accident while driving, the evaluation value being provided by the passenger on the vehicle.

6. The information processing method according to claim 5, wherein the passenger is a person who has paid a fare and has taken a ride on the vehicle.

7. The information processing method according to claim 1, wherein the transaction unit that can be used for the rental payment for the vehicle is a predetermined virtual currency.

8. An information processing server comprising:
one or more processors; and
a memory storing instructions which, when the instructions are executed by the one or more processors, cause the image processing server to:
acquire, from an external device, evaluation information for evaluating a driver who drives a vehicle;
calculate reliability of the driver based on the evaluation information; and
convert the calculated reliability into an amount and grant the converted amount to the driver, the amount being in a transaction unit that can be used for rental payment for the vehicle,
wherein the evaluation information includes status of the rental payment of the driver and at least one of efficiency of labor, an amount of labor and regularity of labor of the driver.

9. A storage medium storing a computer program comprising instructions for causing one or more processors executing the computer program to:
acquire, from an external device, evaluation information for evaluating a driver who drives a vehicle;
calculate reliability of the driver based on the evaluation information; and
convert the calculated reliability into an amount and grant the converted amount to the driver, the amount being in a transaction unit that can be used for rental payment for the vehicle,
wherein the evaluation information includes status of the rental payment of the driver and at least one of efficiency of labor, an amount of labor and regularity of labor of the driver.

10. An information processing system comprising an information processing server and a vehicle, wherein
the vehicle includes a transmitter for transmitting, to the information processing server, evaluation information for evaluating a driver who drives the vehicle, and
the information processing server includes:
one or more processors; and
a memory storing instructions which, when the instructions are executed by the one or more processors, cause the image processing server to:
acquire, from the vehicle, the evaluation information for evaluating the driver's driving of the vehicle;
calculate reliability of the driver based on the evaluation information; and
convert the calculated reliability into an amount and grant the converted amount to the driver, the amount being in a transaction unit that can be used for rental payment for the vehicle,
wherein the evaluation information includes status of the rental payment of the driver and at least one of efficiency of labor, an amount of labor and regularity of labor of the driver.

11. An information processing method comprising:
acquiring, from an external device, evaluation information for evaluating a driver who drives a vehicle;
calculating reliability of the driver based on the evaluation information; and
converting the calculated reliability into an amount and granting the converted amount to the driver, the amount being in a transaction unit that can be used for rental payment for the vehicle,
wherein the evaluation information includes status of the rental payment of the driver, and
the converted amount can be used for payment for the purchase of the vehicle.
